(19) United States
(12) Patent Application Publication
(10) Pub. No.: US 2005/0121876 A1
(43) Pub. Date: Jun. 9, 2005

(54) Floor board

(76) Inventors: Roch Gaudreau, St-Jerome (CA); Christian Bissonnette, St-Jerome (CA); The Hanh Ha, Blainville (CA)

Correspondence Address: Robert Brouillette;BROUILLETTE KOSIE PRINCE, 25th Floor, 1100 Rene-Levesque Boulevard West, Montreal, QC, H3B 5C9, CA

(21) Appl. No.: 10/731,121

(22) Filed: Dec. 10, 2003

(30) Foreign Application Priority Data
Dec. 4, 2003 (CA) 2,452,444

(51) Int. Cl. B60R 3/00

(52) U.S. Cl. 280/169

(57) ABSTRACT

The present invention relates to a floor board which can be attached to various types of rigid frame used in vehicles, structures or equipment. To minimize the formation and accumulation of debris, the floor board of the present invention includes a fixedly positioned supporting plate which is also connected to a flexible body having protuberances which extend away from the supporting plate in such a way as to deform under a loading force.

### FIELD OF THE INVENTION

The present invention relates to a floor board which can be attached to a rigid frame of a structure or of a vehicle.

### BACKGROUND OF THE INVENTION

When subjected to various climatic conditions, outdoor activities involving fixed equipment, structures or vehicles necessitate proper designs to ensure the operator's safety and comfort while using the equipment, structure or vehicle. For instance, an operator may be exposed to heavy winds, snow, rain, dust or cold weather only during a limited period of time.

Although the invention is useful for use on equipment and structures, it will be described in relation to vehicles and more particularly snowmobiles, ATV's and the like.

While driving such vehicles, the operator's hands and feet are usually the less protected body parts since they generally must remain mobile during the use of the vehicle. For instance, the operator uses his/her hands and feet to get on or off the vehicle and to balance himself/herself on while riding it.

Multiple designs have been made to enhance the comfort and security of the vehicle's operators in the areas where the hands and feet are located, without impacting on the general appearance of the vehicles. The floor board is usually the area where the operator puts his feet to get on a vehicle and where he/she rests his/her feet while operating the vehicle. In the past, systems have been designed to provide warmer and safer feet areas since water, ice and dust may accumulate to render those areas uncomfortable, hazardous and slippery.

For instance, Nece (U.S. Pat. No. 5,605,642), Essiembre (U.S. Pat. No. 4,022,378) and Nagata et al. (U.S. Pat. No. 5,568,840) teach about foot warming devices incorporated in or on the frame of a snowmobile to provide heat from a heat element located under a rubberized top layer (Nece), from a heat source such as a radiator located under the floor (Nagata et al.), or from a piping system directed to the foot rest (Essiembre). However, these systems must be linked to an electrical power source or other sources of heat via pipes or wires or must be located near the heat source and they do not isolate the feet of the operator from all of the various types of debris that can accumulate on such floor boards.

In Johnson et al. (U.S. Pat. No. 6,224,134), Walters et al. (U.S. Pat. No. D389,440) and Jarvinen (U.S. Pat. No. D473,822), foot boards for snowmobiles or ATV have been introduced as integrally molded or formed parts. These components have cleats to separate the bottom of the board from the surface where the foot rests (Johnson et al. and Walters et al.) or a flat surface with lateral guards (Jarvinen). However, the components cannot efficiently prevent the formation of ice at the bottom of the boards and they also impose a molded form which is harder to retrofit on the multiple models of existing vehicles already on the market.

There is a need for a floor board which is comfortable, safe and efficient in providing stable support to an object which is positioned on it while it is subjected to lateral movements and/or subjected to different outdoor conditions.

There is also a need for a floor board which minimizes the formation and accumulation of debris.

There is furthermore a need for a floor board which is easy to install and to retrofit on existing equipments, structures and vehicles.

### SUMMARY OF THE INVENTION

The floor board of the present invention includes a fixedly positioned supporting plate which is connected to a flexible body having protuberances extending away from the supporting plate.

An object positioned on the floor board preferably usually rests at the top of the protuberances which deflect under the weight of the object or under any loading force exerted by that object to the floor board.

Since the plurality of protuberances are separated from each other by a deformation zone, the protuberances are allowed to individually or simultaneously deform under the loading force, which minimize the formation and accumulation of debris on the floor board and ensure a more stable grip to the object positioned on the floor board.

There is therefore provided a floor board comprising:
a) a supporting plate having a first rigidity and comprising a top surface and a plurality of openings extending through said plate;
b) a body having a second rigidity and comprising a base and a plurality of protuberances extending from said base;
   wherein said protuberances extend through said openings and away from said top surface.

There is furthermore provided floor board for a frame to support an object, said floor board comprising:
a) a rigid supporting plate having a top surface and being fixedly mounted on said frame;
b) a plurality of flexible protuberances fixed to and extending away from said top surface.

There is furthermore provided a floor board comprising:
a) a supporting plate having a first elasticity modulus and comprising a top surface;
b) a body in contact with said supporting plate, having a second elasticity modulus and comprising at least one protuberance extending away from said top surface;
   whereby said second elasticity modulus is significantly lower than said first elasticity modulus.

Other aspects and many of the attendant advantages will be more readily appreciated as the same becomes better understood by reference to the following detailed description and considered in connection with the accompanying drawings in which like reference symbols designated like elements throughout the figures.

The features of the present invention which are believed to be novel are set forth with particularity in the appended claims.

### BRIEF DESCRIPTION OF THE FIGURES

FIG. 1 is an isometric view showing a floor board with a flexible structure of the present invention.

FIG. 2 is a bottom view of the floor board shown in FIG. 1.

FIG. 3 is a section view taken along line 3-3 of the floor board of FIG. 2.

FIG. 4 is an isometric view of a snowmobile onto which the floor board of FIG. 1 is installed.

### DETAILED DESCRIPTION OF A PREFERRED EMBODIMENT

The present invention relates to a floor board structure which can be assembled to the rigid frame of equipments, structures and/or vehicles.

The floor board assembly of the present invention maximizes the “gripping” of an object which exerts a load on it like a lateral movement force. The floor board also significantly reduces the formation and accumulation of debris on itself while being exposed to various types of environments.

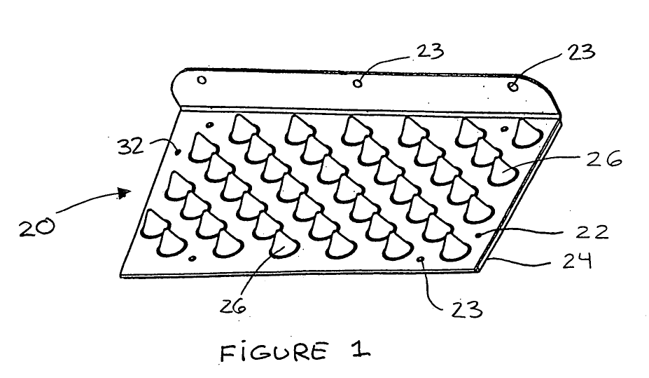

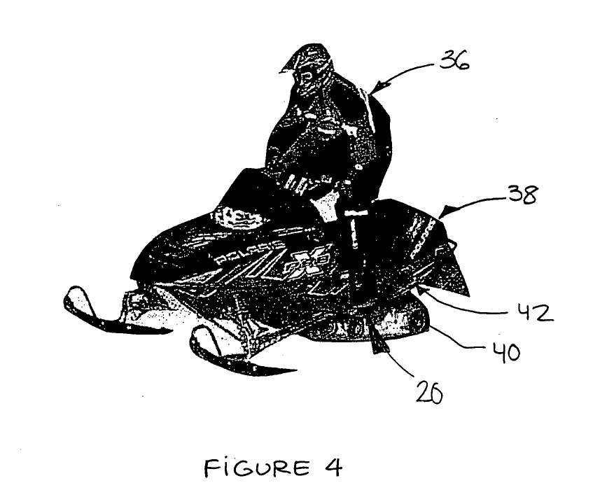

FIG. 1 illustrates a floor board 20 of the present invention which is made from the assembly of a supporting plate 22 and a body 24 which is preferably flexible. Since the floor board 20 is usually attached or positioned on a rigid frame of a vehicle (such as the snowmobile of FIG. 4) or any other equipment or structure, its size, thickness or shape is designed according to the configuration of that frame.

The plate 22 is preferably made from a metallic material such as aluminum or steel, or from any rigid polymeric material. The plate 22 ensures the stability of the foot board 20 and when it is to be rigidly fixed to a frame such as the floor of equipment (not shown) located outdoors, the plate 22 preferably includes holes 23 corresponding to holes of the floor (not shown) onto which it is to be installed. Therefore, the plate 22 can be attached to any rigid support with the help of bolts, screws or rivets going through the holes 23, or by any other attachment means known in the art which gives the same result.

The body 24 is preferably selected depending on its flexibility, or deformation potential under a loading force. An elastomeric material like rubber is preferably selected since it is relatively inexpensive and available with various physical properties.

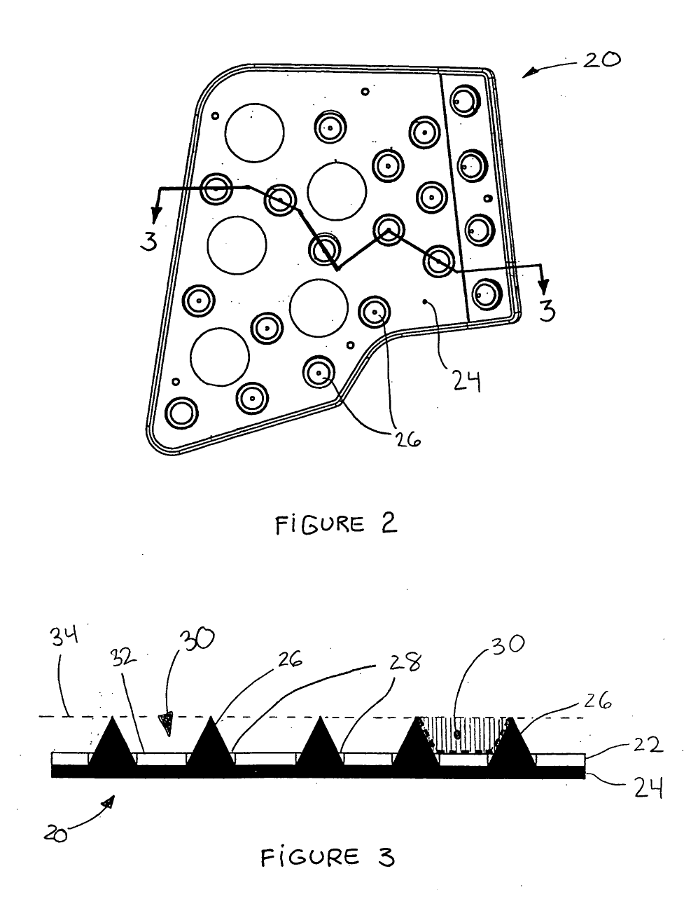

In the floor board 20 embodiment shown in FIGS. 1, 2 and 3, the flexible body 24 consists of a thin layer of elastomeric material located underneath the supporting plate 22. The flexible body 24 also includes a plurality of protuberances 26 disposed according to a pattern which generally replicates a pattern of holes 28 on the supporting plate 22. The protuberances 26 usually go through and extend away from the supporting plate 22.

The number, the size and the localization of the protuberances 26 influence the level of stability and gripping for the object located on the floor board 20. The space between two protuberances 26 defines a deformation zone 30. In the embodiment of FIG. 3, the deformation zone consists of the volume defined by the top surface 32 of the supporting plate 22 where there is no hole 28, by the sides of protuberances 26 and the top 34 of the protuberances 26, which is the highest point where the protuberances 26 extend away from the supporting plate 22.

At the top 34, the plurality of protuberances 26 act together as a support surface for any object positioned on it. As illustrated in FIG. 4, the operator 36 of a snowmobile 38 positions each of his feet 40 on the protuberances 26 of the floor board 20. In this embodiment, the floor board 20 is rigidly attached to the frame 42 of the snowmobile 38, such that the protuberances 26 extend away from the supporting plate 22 and from the frame 42. Each foot 40 of the operator 36 is positioned on the protuberances 26 and usually, at the top 34. Since the flexible body 24 is preferably made from a flexible material which is significantly more flexible than the supporting plate 22, the foot 40 resting on the floor board 20 has a more stable and efficient grip than it would have had on a flat or rigid support.

When located outside and/or subjected to various exterior conditions like rain, cold and dust, the floor board 20 is exposed to the accumulation of debris, water, or the formation of ice in its deformation zone 30. This phenomenon usually reduces the comfort and the stability of anything positioned on the floor board 20 and generally affects the general appearance of the vehicle or equipment onto which it is installed.

By having a plurality of protuberance 26 preferably made from a flexible material and surrounded by the deformation zone 30, this effect is significantly minimized. Indeed, under a particular loading force like the weight of the user transmitted through the foot 40, a lateral load or the load of any other object resting on the floor board 20, the protuberances 26 deform in the deformation zone 30, but generally maintain their contact and cohesion with the object inducing the load. On the other hand, the supporting plate 22 which is preferably less flexible than the flexible body 24 remains generally dimensionally stable under the same load.

This induced relative movement between the flexible body 24 and the supporting plate 22 has a tendency to dislodge and move anything that is stuck in the deformation zone 30 along the direction of deformation of the protuberances 26. Therefore, the formation of ice or the accumulation of debris in the deformation zone 30 is minimized. Also already formed ice which is lodged in the deformation zone 30 has more chances to be broken under the load which is imposed on the deforming flexible protuberances 26.

As a general rule, the material for the flexible body 24 is selected such that it is preferably significantly more flexible than the material of the supporting plate 22 or in other words, that the body 24 has a different deforming behavior than the plate 22 when both subjected to the same loading force. The difference between deforming behaviors can be measured when comparing the elastic modulus of each material at a given temperature. For linear materials (materials which elastically deform linearly) like most metals and alloys the stress on a material is given by the following relation (1):
σ=E×ε (1)
where:
σis the stress;
E is the elasticity Modulus or Young's modulus;
ε is the elastic deformation.

Two materials subjected to a same stress can therefore be compared according to the following relations (2), (3):
Eₘₐₜ₁×εₘₐₜ₁=Eₘₐₜ₂×εₘₐₜ₂ (2)
Eₘₐₜ₁/Eₘₐₜ₂=εₘₐₜ₂/εₘₐₜ₁ (3)

Even though non-linear materials such as elastomeric materials do not linearly deform elastically, its Young's modulus can been experimentally estimated under small loads at a given temperature. Since both the supporting plate 22 and flexible body 24 are generally subjected to the same loading force and at the same temperature when installed or in use, their respective Young's Modulus may be used as a comparison to choose the proper materials for a specific application when a floor board 20 is required. Some values of Young's modulus for some materials are given hereinbelow as a reference only:
E_{steel ASTM-A36}=29×10⁶ psi
E_{aluminum alloys}=9×10⁶ psi
E_{rubber}=1000 psi

From equation (3),
Eₛₜₑₑₗ/E_{rubber}=29000
Eₐₗᵤₘᵢₙᵤₘ/E_{rubber}=9000
Eₛₜₑₑₗ/Eₐₗᵤₘᵢₙᵤₘ=3.22

When comparing two materials to become a supporting plate 22 and a flexible body 24, their Young's modulus must be significantly different. From this example, it is seen that (E_{material for supporting plate})/(E_{material for flexible body})≧1000.

Although a preferred embodiment of the invention has been described in detail herein and illustrated in the accompanying figures, it is to be understood that the invention is not limited to this precise embodiment and that various changes and modifications may be effected therein without departing from the scope or spirit of the present invention.

1. A floor board comprising:
a) a supporting plate having a first rigidity and comprising a top surface and a plurality of openings extending through said plate;
b) a body having a second rigidity and comprising a base and a plurality of protuberances extending from said base;
wherein said protuberances extend through said openings and away from said top surface.

2. A floor board as claimed in claim 1, wherein said first rigidity is higher than said second rigidity.

3. A floor board as claimed in claim 1, wherein said base is located underneath said supporting plate.

4. A floor board as claimed in claim 3, wherein said protuberances have a conical shape.

5. A floor board as claimed in claim 1, wherein said body is made from an elastomeric material.

6. A floor board for a frame to support an object, said floor board comprising:
a) a rigid supporting plate having a top surface and being fixedly mounted on said frame;
b) a plurality of flexible protuberances fixed to and extending away from said top surface.

7. A floor board as claimed in claim 6, wherein said frame is the frame of a vehicle.

8. A floor board as claimed in claim 7, wherein said vehicle is a snowmobile.

9. A floor board as claimed in claim 7, wherein said vehicle is an ATV.

10. A floor board as claimed in claim 6, wherein said frame is the frame of outdoor equipment.

11. A floor board comprising:
a) a supporting plate having a first elasticity modulus and comprising a top surface;
b) a body in contact with said supporting plate, having a second elasticity modulus and comprising at least one protuberance extending away from said top surface;
whereby said second elasticity modulus is significantly lower than said first elasticity modulus.

12. A floor board as claimed in claim 13, wherein said second elasticity modulus is 1000 times lower than said first elasticity modulus.
